(19) United States
(12) Patent Application Publication
(10) Pub. No.: US 2026/0151942 A1
(43) Pub. Date: Jun. 4, 2026

(54) METHOD OF MOLDING FIBER REINFORCED RESIN IMPELLER

(71) Applicant: Mitsubishi Electric Corporation, Chiyoda-ku, Tokyo (JP)

(72) Inventors: Rong ZOU, Chiyoda-ku, Tokyo (JP); Yasuo OZEKI, Chiyoda-ku, Tokyo (JP); Toshikatsu ARAI, Chiyoda-ku, Tokyo (JP)

(73) Assignee: Mitsubishi Electric Corporation, Chiyoda-ku, Tokyo (JP)

(21) Appl. No.: 18/704,752

(22) PCT Filed: Jan. 10, 2023
(86) PCT No.: PCT/JP2023/000257

§ 371 Date: Apr. 25, 2024

(30) Foreign Application Priority Data
Jan. 20, 2022 (JP) 2022-007031

(51) Int. Cl. B29C 45/00; B29C 45/78; B29L 31/08

(52) U.S. Cl. CPC B29C 45/0005; B29C 45/78; B29C 2945/76006; B29C 2945/7604; B29C 2945/76277; B29L 2031/087

(57) ABSTRACT

The present application is to provide a method of molding a fiber reinforced resin impeller and a method of molding a fiber reinforced resin gear, which can monitor in real time.

In the method of molding the fiber reinforced resin impeller in which fiber reinforced resin is injected from a plurality of gates of a metal mold to mold the fiber reinforced resin impeller which includes a drum and a plurality of blade portions arranged on the outer circumference of the drum, the temperatures of resin are measured by temperature sensors arranged near a plurality of gate portions of the metal mold which correspond to the blade portions; rise timings are measured per one time of temperature waveforms collected by the temperature sensor; and the respective rise timings of the temperature sensors are compared and monitored.

The present application relates to a method of molding a fiber reinforced resin impeller and a method of molding a fiber reinforced resin gear.

### BACKGROUND ART

Fiber orientation of fiber reinforced resin influences strength. A fiber reinforced resin impeller (examples: propeller fan, sirocco fan, turbofan, or the like) generates bending stress by centrifugal force during rotation. The orientation of fiber is influenced by a flow of resin and if the flow of resin changes during molding, the orientation of fiber also changes. When fiber at a maximum stress portion is oriented in a direction perpendicular to a stress generation direction, there exists a risk that links to a deterioration in strength of the impeller. Furthermore, there similarly exists a risk that links to a deterioration in strength also in a fiber reinforced resin gear.

Moreover, nondestructive measurement (computed tomography (CT) scanning or the like) of fiber orientation is expensive and high difficulty level of measurement and thus a method of monitoring the fiber orientation during molding has not been achieved yet. Accordingly, there needs to develop a method of monitoring the strength of the fiber reinforced resin impeller and the fiber reinforced resin gear, the method being able to predict fiber orientation in real time by means of resin pressure and a temperature sensor.

### RELATED ART DOCUMENT

### Patent Document

Patent Document 1: JP-A-H10(1998 )-77995

### SUMMARY OF THE INVENTION

### Problems to be Solved by the Invention

In the above conventional one, there has not been a method of monitoring the fiber orientation in real time during molding of the fiber reinforced resin impeller. Particularly, a problem exists in that when a gate of a metal mold is clogged or when the gate is worn, the resin flow changes and accordingly the fiber orientation changes and there exists a risk that links to a deterioration in strength of a blade portion of the fiber reinforced resin impeller.

Furthermore, a problem exists in that there has not been a method of monitoring filling balance of respective blade portions of the fiber reinforced resin impeller in real time during molding.

Moreover, a problem exists in that there has not been a method of monitoring a void (cavity) occurrence state of the fiber reinforced resin impeller in real time during molding.

Additionally, there has not been a method of monitoring the fiber orientation in real time during molding of the fiber reinforced resin gear. A problem exists in that, particularly, when the gate of the metal mold is clogged or when the gate is worn, the resin flow changes and accordingly the fiber orientation changes and there exists a risk that links to a deterioration in strength of the fiber reinforced resin gear.

The present application is to disclose a technique for solving the foregoing problem and an object of the present application is to provide a method of molding a fiber reinforced resin impeller which can monitor during molding of the fiber reinforced resin impeller and a method of molding a fiber reinforced resin gear which can monitor during molding of the fiber reinforced resin gear.

### Means for Solving the Problems

A method of molding a fiber reinforced resin impeller disclosed in the present application is a method of molding a fiber reinforced resin impeller in which fiber reinforced resin is injected from a plurality of gates of a metal mold to mold the fiber reinforced resin impeller which includes a drum and a plurality of blade portions arranged on the outer circumference of the drum. In the method, the temperatures of resin are measured by temperature sensors arranged near a plurality of gate portions of the metal mold which correspond to the blade portions; and rise timings are measured per one time of temperature waveforms collected by the temperature sensors to monitor rise states.

Furthermore, a method of molding a fiber reinforced resin impeller disclosed in the present application is a method of molding a fiber reinforced resin impeller in which fiber reinforced resin is injected from a plurality of gates of a metal mold to mold the fiber reinforced resin impeller which includes a drum and a plurality of blade portions arranged on the outer circumference of the drum. In the method, the pressures of resin are measured by pressure sensors arranged on tip end portions of the plurality of blade portions of the metal mold which correspond to the blade portions; and peak values are measured per one time of pressure waveforms collected by the pressure sensors to monitor the states of the peak values.

Moreover, a method of molding a fiber reinforced resin impeller disclosed in the present application is a method of molding a fiber reinforced resin impeller in which fiber reinforced resin is injected from a plurality of gates of a metal mold to mold the fiber reinforced resin impeller which includes a drum and a plurality of blade portions arranged on the outer circumference of the drum. In the method, the pressures of resin are measured by pressure sensors arranged on tip end portions of the plurality of blade portions of the metal mold which correspond to the blade portions; and rise timings are measured per one time of pressure waveforms collected by the pressure sensors to monitor rise states.

### Advantageous Effect of the Invention

According to the method of molding the fiber reinforced resin impeller disclosed in the present application, the rise timings are measured per one time of the temperature waveforms collected by the temperature sensors that measure the temperatures of resin near the plurality of gate portions which respectively correspond to the plurality of blade portions and the respective rise timings of the temperature sensors can be compared and monitored.

Furthermore, according to the method of molding the fiber reinforced resin impeller disclosed in the present application, the peak values are measured per one time of the pressure waveforms collected by the pressure sensors that measure the pressures of resin of the tip end portions of the plurality of blade portions which respectively correspond to a plurality of gate portions and the states of the peak values can be monitored.

Moreover, according to the method of molding the fiber reinforced resin impeller disclosed in the present application, the rise timings are measured per one time of the pressure waveforms collected by the pressure sensors that measure the pressures of resin of the tip end portions of the plurality of blade portions which respectively correspond to a plurality of gate portions and the respective rise timings of the pressure sensors can be compared and monitored.

### BRIEF DESCRIPTION OF THE DRAWINGS

FIG. 1 is a perspective view showing a fiber reinforced resin impeller related to a method of molding the fiber reinforced resin impeller according to Embodiments 1 to 4;

FIGS. 2A and 2B are an image view showing fiber orientation of fiber reinforced resin material related to the method of molding the fiber reinforced resin impeller according to Embodiments 1 to 4;

FIGS. 3A to 3C are a waveform view showing a temperature state in the occurrence of clogging of a gate in Embodiment 1;

FIGS. 4A to 4C are a waveform view showing a temperature state during wear of the gate in Embodiment 1;

FIG. 5 is an image view showing an installation cross section of a temperature sensor in Embodiment 1;

FIG. 6 is a waveform view showing a pressure state in Embodiment 2;

FIG. 7 is a perspective view showing a maximum stress portion and a stress generation direction in Embodiment 3;

FIGS. 8A to 8C are a waveform view showing a pressure state in Embodiment 3;

FIG. 9 is an image view showing an installation place of a pressure sensor in Embodiment 4;

FIG. 10 is a plan view showing a fiber reinforced resin gear related to a method of molding the fiber reinforced resin gear according to Embodiment 5;

FIGS. 11A and 11B are a plan view showing another example of the fiber reinforced resin gear related to the method of molding the fiber reinforced resin gear according to Embodiment 5, FIG. 11A is a plan view showing the front of the fiber reinforced resin gear, and FIG. 11B is a plan view showing the back of the fiber reinforced resin gear; and

FIG. 12 is a sectional view seen from lateral directions of FIGS. 11A and 11B in the fiber reinforced resin gear related to the method of molding the fiber reinforced resin gear according to Embodiment 5.

### MODE FOR CARRYING OUT THE INVENTION

### Embodiment 1

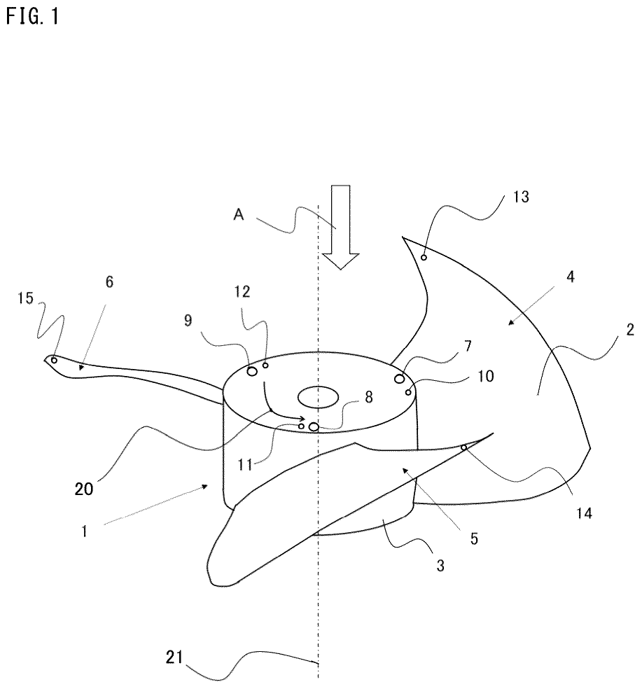

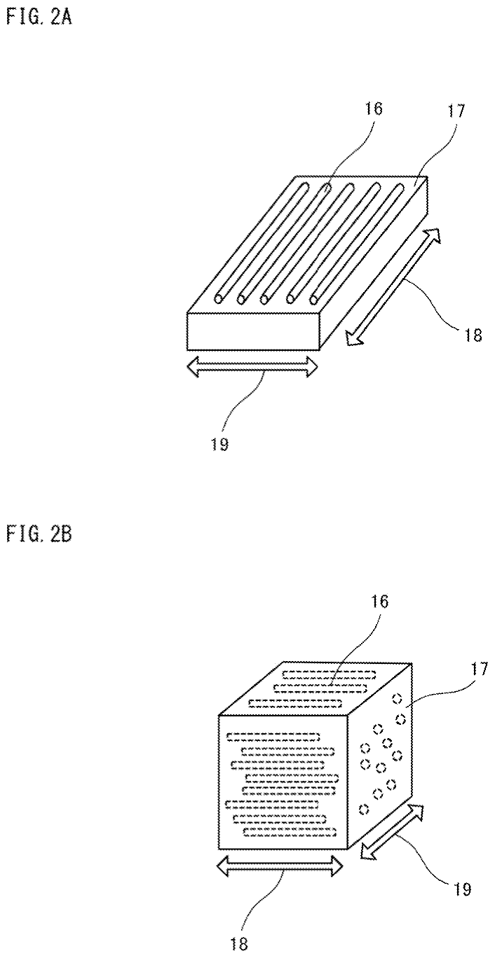

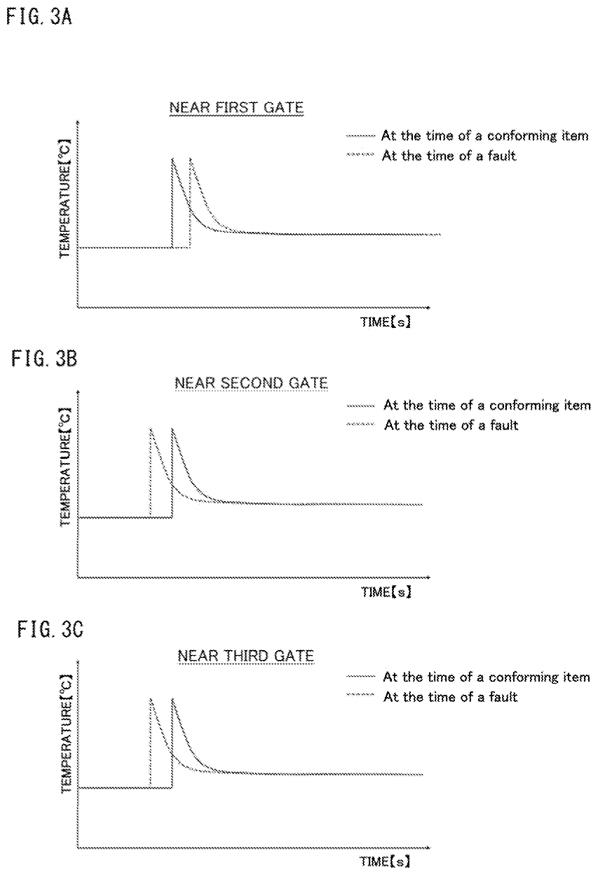

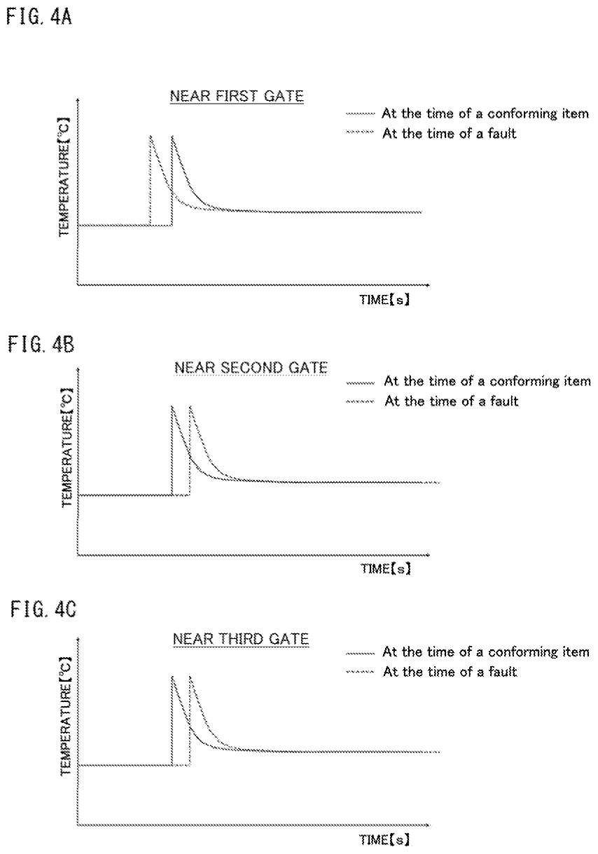

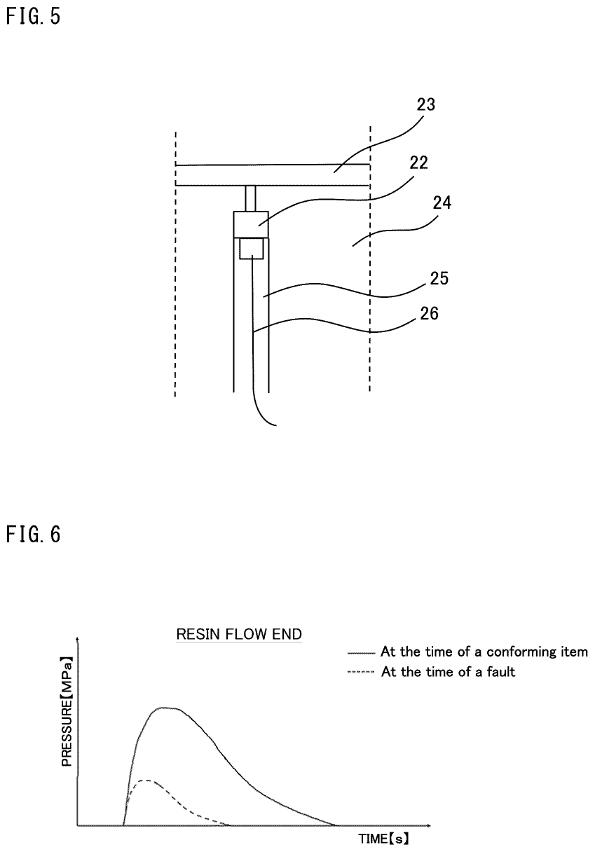

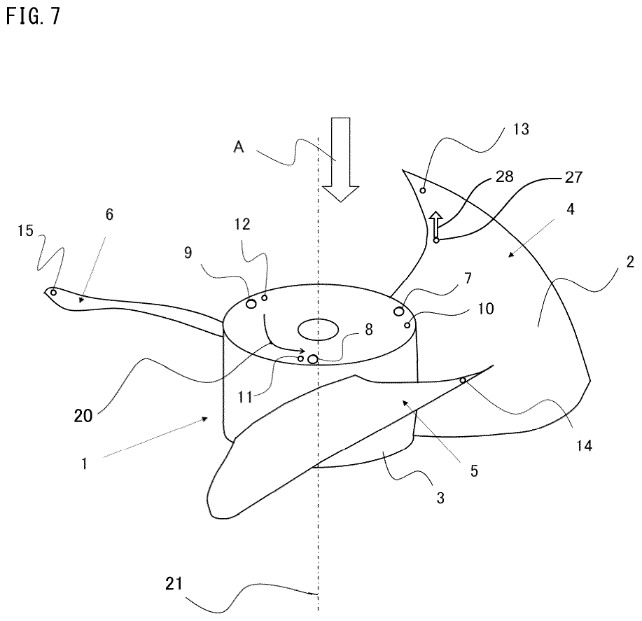

Hereinafter, Embodiment 1 of the present application will be described on the basis of FIG. 1 to FIG. 5; and, in each of the drawings, identical or equivalent members and parts will be described with the same reference numerals assigned thereto. FIG. 1 is a perspective view showing a fiber reinforced resin impeller related to a method of molding the fiber reinforced resin impeller according to Embodiment 1 to 3. FIGS. 2A and 2B are an image view showing fiber orientation of fiber reinforced resin material related to the method of molding the fiber reinforced resin impeller according to Embodiment 1 to 3. FIGS. 3A to 3C are a waveform view showing a temperature state in the occurrence of clogging of a gate in Embodiment 1. FIGS. 4A to 4C are a waveform view showing a temperature state during wear of the gate in Embodiment 1. FIG. 5 is an image view showing an installation cross section of a temperature sensor in Embodiment 1.

The fiber reinforced resin impeller uses resin, which contains glass fiber, carbon fiber, or the like, as a material and is molded by an injection molding machine and an injection molding metal mold. The number of blades of the fiber reinforced resin impeller is two or more and a case with three blades is shown as an example. Glass fiber, carbon fiber, or the like, each of which has a diameter of 5 μm to 15 μm and a length of 0.1 mm to 15 mm, is used. Resin is thermoplastic resin (examples: poly phenylene sulfide (PPS), polybutylene terephthalate (PBT), polypropylene (PP), polystyrene (PS), polycarbonate (PC), acrylonitrile butadiene styrene (ABS), acrylonitrile styrene (AS), and polyether ether ketone (PEEK) ). Furthermore, the percentage of fiber content is 5% to 70% in weight ratio.

In the injection molding metal mold of a fiber reinforced resin impeller 1 of the present application, a first gate 7, a second gate 8, and a third gate 9, which respectively correspond to a first blade portion 4, a second blade portion 5, and a third blade portion 6, are formed on a drum 3; a first temperature sensor 10, a second temperature sensor 11, and a third temperature sensor 12, which measure the temperatures of resin, are provided in the respective vicinities of the first gate 7, the second gate 8, and the third gate 9; and the above temperature sensors and the above gates are installed on the same circumference. As shown in FIG. 5, a hole for sensor installation is opened in a metal mold 24 and a sensor main body 22 is installed in the metal mold 24. The tip end of the sensor (sensing portion) is brought into contact with resin 23. The sensor main body 22 is retained in a nesting of the metal mold 24. Sensor wiring 26 is led out to the outside via a groove for sensor wiring 25 of the metal mold 24. Incidentally, reference numeral 20 denotes a rotation direction and 21 denotes the center of a rotation axis.

As shown in FIGS. 2A and 2B, orientation of fiber 16 in resin 17 influences the strength of the resin 17. When the fiber 16 is oriented in the same direction as a stress direction, the strength of material is enhanced. Meanwhile, when the fiber 16 is oriented in a direction perpendicular to the stress direction, the strength of material is weakened. Furthermore, the orientation of the fiber 16 is influenced by a flow of the resin 17. The strength of material in a flow direction 18 of the resin 17 is high and the strength of material in a width direction 19 of the resin 17 is low.

Bending stress is generated in the fiber reinforced resin impeller 1 by centrifugal force during rotation. In order to secure the strength at a maximum stress portion of the fiber reinforced resin impeller 1, the fiber orientation is designed so as to be in the same direction as a stress generation direction to the maximum extent.

The orientation of the fiber 16 is influenced by the flow of the resin 17; and if the flow of the resin 17 changes during molding, the orientation of the fiber 16 also changes. When the fiber 16 at the maximum stress portion is oriented in the direction perpendicular to the stress generation direction, there exists a risk that links to a deterioration in strength of the fiber reinforced resin impeller 1.

When any one of the first gate 7, the second gate 8, and the third gate 9 of the fiber reinforced resin impeller 1 is clogged or when any one of the first gate 7, the second gate 8, and the third gate 9 is worn, the flow of the resin 17 changes. Under that influence, the orientation of the fiber 16 in the resin 17 changes and when the fiber 16 at the maximum stress portion is oriented in the direction perpendicular to the stress generation direction, there exists the risk that links to the deterioration in strength of the fiber reinforced resin impeller 1.

Therefore, the temperatures of resin reached the first gate 7, the second gate 8, and the third gate 9 are respectively measured by the first temperature sensor 10, the second temperature sensor 11, and the third temperature sensor 12; rise timings are measured per one time of temperature waveforms; and the respective rise timings of the first temperature sensor 10, the second temperature sensor 11, and the third temperature sensor 12 are compared and monitored.

The number of gates of the fiber reinforced resin impeller 1 having three blades 2 is three, which are the first gate 7, the second gate 8, and the third gate 9. For example, when the first gate 7 of one of them is clogged or becomes small in diameter and the amount of passing resin is decreased, the rise timing of the first temperature sensor near the first gate 7 is more delayed than normal time, as shown in FIG. 3A. At the same time, as shown in FIG. 3B and FIG. 3C, the rise timings of the second temperature sensor 11 and the third temperature sensor 12 respectively near the remaining two second gate 8 and third gate 9 are more advanced than normal time. When these phenomena occur, it is turned out that the first gate 7 is clogged and it can be seen that the flow of resin changes and there exists a risk that links to a deterioration in strength of the blade 2. At this time, a defect signal is outputted to a molding machine, a sorting machine, or the like and molding stop or defect sorting operation can be put in action.

Furthermore, when the first gate 7 of one of them becomes large in diameter due to the wear and thus the amount of passing resin is increased, the rise timing of the first temperature sensor near the first gate 7 is more advanced than normal time, as shown in FIG. 4A. At the same time, as shown in FIG. 4B and FIG. 4C, the rise timings of the second temperature sensor 11 and the third temperature sensor 12 respectively near the remaining two second gate 8 and third gate 9 are more delayed than normal time. When these phenomena occur, it is turned out that the first gate 7 is worn and it can be seen that the flow of resin changes and there exists a risk that links to a deterioration in strength of the fiber reinforced resin impeller. At this time, a defect signal is outputted to the molding machine, the sorting machine, or the like and molding stop or defect sorting operation can be put in action.

Moreover, when these phenomena occur, a difference arises in each weight of the first blade portion 4, the second blade portion 5, and the third blade portion 6, balance during rotation deteriorates and there exists a possibility that links to a deterioration in the amount of blowing air or an increase in noise. Therefore, when any of the first gate 7, the second gate 8, and the third gate 9 of the metal mold is clogged or when any of the first gate 7, the second gate 8, and the third gate 9 is worn, a change in fiber orientation due to a change in resin flow can be monitored in real time during molding by the method of molding the fiber reinforced resin impeller according to Embodiment 1.

Additionally, it can be monitored in real time during molding whether there exists a change in generation position of a weld (resin interflow portion) of the fiber reinforced resin impeller due to a change in resin flow; thus, the occurrence of a deterioration in strength of the fiber reinforced resin impeller can be prevented.

Besides, it can be monitored in real time during molding whether there exists a change in each filling balance of the first blade portion 4, the second blade portion 5, and the third blade portion 6 of the fiber reinforced resin impeller 1 due to a change in resin flow; thus, each dimensional change in the first blade portion 4, the second blade portion 5, and the third blade portion 6 of the fiber reinforced resin impeller 1 and an increase in noise and vibration due to unbalance can be prevented. Therefore, blade balance inspection of the fiber reinforced resin impeller 1 can be deleted.

In addition, when each balance of the first blade portion 4, the second blade portion 5, and the third blade portion 6 deteriorates, balance can be improved by adjusting values of monitoring points by means of, for example, adjustment of a gate size and adjustment of opening and closing timing of a hot runner valve gate.

### Embodiment 2

Also in this Embodiment 2, as with the above Embodiment 1, FIG. 1 and FIGS. 2A and 2B are used in common. A fiber reinforced resin impeller 1 has a first gate 7, a second gate 8, and a third gate 9, which respectively correspond to a first blade portion 4, a second blade portion 5, and a third blade portion 6; and a first pressure sensor 13, a second pressure sensor 14, and a third pressure sensor 15 are respectively provided at the ends of resin flow of the respective tip ends of the first blade portion 4, the second blade portion 5, and the third blade portion 6. The first gate 7, the second gate 8, and the third gate 9 are installed on the same circumference; and the first pressure sensor 13, the second pressure sensor 14, and the third pressure sensor 15 are installed on the same circumference.

Orientation of fiber in resin influences the strength of resin. As shown in FIGS. 2A and 2B, when fiber 16 is oriented in the same direction as a stress direction, the strength of material is high.

When a flow direction of resin 17 changes due to a molding machine defect or the like, orientation of fiber 16 in the resin 17 changes, and the fiber 16 is oriented in a direction perpendicular to the direction of strength request, there exists a risk that links to a deterioration in strength of the fiber reinforced resin impeller 1. Therefore, the pressures of resin reached the ends of resin flow of the respective tip ends of the first blade portion 4, the second blade portion 5, and the third blade portion 6 of the fiber reinforced resin impeller 1 are respectively measured by the first pressure sensor 13, the second pressure sensor 14, and the third pressure sensor 15 and pressure peak values are measured per one time of pressure waveforms.

When the amounts of resin filling to the first blade portion 4, the second blade portion 5, and the third blade portion 6 are small due to a molding machine defect or the like, the peak values of the first pressure sensor 13, the second pressure sensor 14, and the third pressure sensor 15 at the ends of resin flow, which respectively correspond to the first blade portion 4, the second blade portion 5, and the third blade portion 6, are smaller than those of normal time, as shown in FIG. 6.

When these phenomena occur, resin filling shortage is turned out, there is a large possibility that a short shot, a void, or the like occurs, and there exists a risk that links to a deterioration in strength of the fiber reinforced resin impeller 1.

At this time, a defect signal is outputted to a molding machine, a sorting machine, or the like and molding stop or defect sorting operation can be put in action.

Furthermore, the number of gates of the fiber reinforced resin impeller 1 having three blades 2 is three, which are the first gate 7, the second gate 8, and the third gate 9. When the first gate 7 of one of them is clogged or becomes small in diameter and the amount of passing resin is decreased, a peak value of the first pressure sensor 13 at the end of resin flow of the first blade portion 4 corresponding to the first gate 7 is smaller than that of normal time.

When these phenomena occur, resin filling shortage of the first blade portion 4 corresponding to the first gate 7 is turned out, there is a large possibility that a short shot, a void, or the like occurs, and it can be seen that there exists a risk that links to a deterioration in strength of the fiber reinforced resin impeller 1. At this time, a defect signal is outputted to the molding machine, the sorting machine, or the like and molding stop or defect sorting operation can be put in action.

Moreover, when these phenomena occur, a difference arises in each weight of the first blade portion 4, the second blade portion 5, and the third blade portion 6, balance during rotation deteriorates and there exists a possibility that links to an increase in noise and vibration.

By this configuration, when any of the first gate 7, the second gate 8, and the third gate 9 of the fiber reinforced resin impeller 1 is clogged and when a molding machine defect occurs, filling shortage of resin and a change in fiber orientation due to a change in resin flow can be monitored in real time during molding and the occurrence of a deterioration in strength of the fiber reinforced resin impeller 1 can be prevented. Furthermore, the presence or absence of the occurrence of a void (cavity) due to resin filling shortage of the fiber reinforced resin impeller 1 can be monitored in real time during molding. The occurrence of a deterioration in strength of the fiber reinforced resin impeller 1 can be prevented.

Besides, it can be monitored in real time during molding whether there exists a change in each filling balance of the first blade portion 4, the second blade portion 5, and the third blade portion 6 of the fiber reinforced resin impeller 1 due to a change in resin flow; and each dimensional change in the first blade portion 4, the second blade portion 5, and the third blade portion 6 of the fiber reinforced resin impeller 1 and a deterioration in the amount of blowing air or an increase in noise due to unbalance can be prevented. Therefore, blade balance inspection of the fiber reinforced resin impeller 1 can be deleted.

In addition, when each balance of the first blade portion 4, the second blade portion 5, and the third blade portion 6 deteriorates, balance can be improved by adjusting values of monitoring points by means of, for example, adjustment of a gate size and adjustment of opening and closing timing of a hot runner valve gate.

### Embodiment 3

Also in this Embodiment 3, as with the above Embodiment 1, FIG. 1 and FIGS. 2A and 2B are used in common. A fiber reinforced resin impeller 1 has a first gate 7, a second gate 8, and a third gate 9, which respectively correspond to a first blade portion 4, a second blade portion 5, and a third blade portion 6; a first pressure sensor 13, a second pressure sensor 14, and a third pressure sensor 15 are respectively provided at the ends of resin flow of the respective tip ends of the first blade portion 4, the second blade portion 5, and the third blade portion 6; and the above gates and the above pressure sensors are installed on the same circumference—this configuration is the same as the above Embodiment 2.

When the first gate 7, the second gate 8, and the third gate 9 of the fiber reinforced resin impeller 1 are clogged or when the first gate 7, the second gate 8, and the third gate 9 are worn, a flow of resin changes. Under that influence, when orientation of fiber in resin changes and fiber at a maximum stress portion 27 is oriented in a direction perpendicular to a stress generation direction 28, there exists a risk that links to a deterioration in strength of the fiber reinforced resin impeller 1.

Therefore, the pressures of resin reached the ends of resin flow of the respective tip ends of the first blade portion 4, the second blade portion 5, and the third blade portion 6 of the fiber reinforced resin impeller 1 are respectively measured by the first pressure sensor 13, the second pressure sensor 14, and the third pressure sensor 15; rise timings are measured per one time of pressure waveforms; and the respective rise timings of the first pressure sensor 13, the second pressure sensor 14, and the third pressure sensor 15 are compared and monitored.

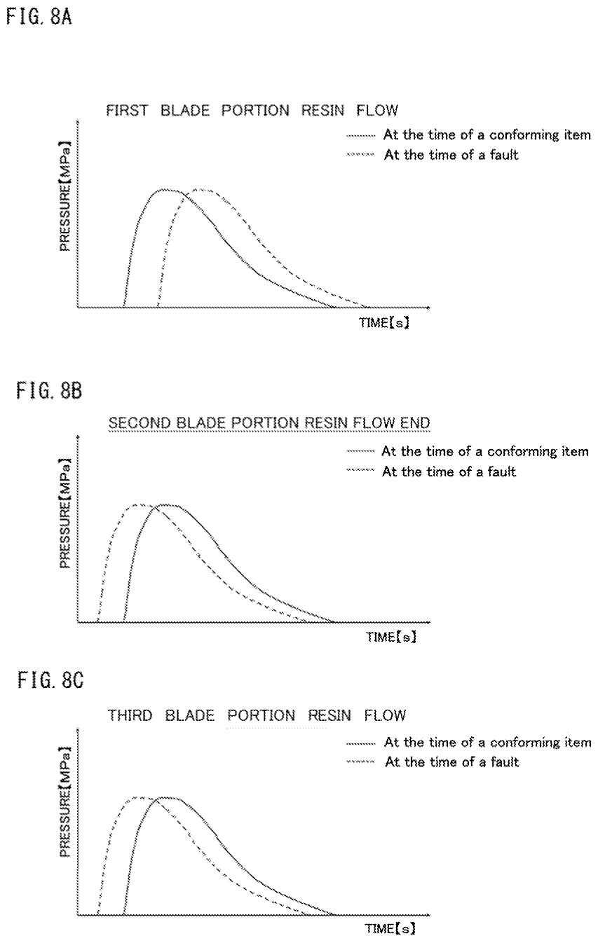

The number of gates of the fiber reinforced resin impeller 1 having three blades 2 is three, which are the first gate 7, the second gate 8, and the third gate 9. When the first gate 7 of one of them is clogged or becomes small in diameter and the amount of passing resin is decreased, the rise timing of the first pressure sensor 13 at the end of resin flow of the tip end of the first blade portion 4 corresponding to the first gate 7 is more delayed than normal time, as shown in FIG. 8A. At the same time, as shown in FIG. 8B and FIG. 8C, the rise timings of the second pressure sensor 14 and the third pressure sensor 15 at the ends of resin flow of the respective tip ends of the second blade portion 5 and the third blade portion 6 which respectively correspond to the remaining two second gate 8 and third gate 9 are more advanced than normal time. When these phenomena occur, it is turned out that the first gate 7 is clogged; and it can be seen that the flow of resin changes and there exists a risk that links to a deterioration in strength of the fiber reinforced resin impeller 1. At this time, a defect signal is outputted to a molding machine, a sorting machine, or the like and molding stop or defect sorting operation can be put in action.

When the first gate 7 of one of them becomes large in diameter due to the wear and the amount of passing resin is increased, the rise timing of the first pressure sensor 13 at the end of resin flow of the tip end of the first blade portion 4 corresponding to the first gate 7 is more advanced than normal time.

At the same time, the rise timings of the second pressure sensor 14 and the third pressure sensor 15 at the ends of resin flow of the respective tip ends of the second blade portion 5 and the third blade portion 6 which respectively correspond to the remaining two second gate 8 and third gate 9 are more delayed than normal time. When these phenomena occur, it is turned out that the first gate 7 is worn and it can be seen that the flow of resin changes and there exists a risk that links to a deterioration in strength of the fiber reinforced resin impeller 1. At this time, a defect signal is outputted to the molding machine, the sorting machine, or the like and molding stop or defect sorting operation can be put in action.

Furthermore, when these phenomena occur, a difference arises in each weight of the first blade portion 4, the second blade portion 5, and the third blade portion 6, balance during rotation deteriorates and there exists a possibility that links to an increase in noise and vibration.

By this configuration, when any of the first gate 7, the second gate 8, and the third gate 9 of the fiber reinforced resin impeller 1 is clogged or when any of the first gate 7, the second gate 8, and the third gate 9 is worn, a change in fiber orientation due to a change in resin flow can be monitored in real time during molding and the occurrence of a deterioration in strength of the fiber reinforced resin impeller 1 can be prevented.

Moreover, it can be monitored in real time during molding whether there exists a change in generation position of a weld (resin interflow portion) of the fiber reinforced resin impeller due to a change in resin flow and the occurrence of a deterioration in strength of the fiber reinforced resin impeller 1 can be prevented.

Additionally, it can be monitored in real time during molding whether there exists a change in each filling balance of the first blade portion 4, the second blade portion 5, and the third blade portion 6 of the fiber reinforced resin impeller 1 due to a change in resin flow; and each dimensional change in the first blade portion 4, the second blade portion 5, and the third blade portion 6 of the fiber reinforced resin impeller 1 and a deterioration in the amount of blowing air or an increase in noise due to unbalance can be prevented. Therefore, blade balance inspection of the fiber reinforced resin impeller 1 can be deleted.

In addition, when each balance of the first blade portion 4, the second blade portion 5, and the third blade portion 6 deteriorates, balance can be improved by adjusting values of monitoring points by means of, for example, adjustment of a gate size and adjustment of opening and closing timing of a hot runner valve gate.

### Embodiment 4

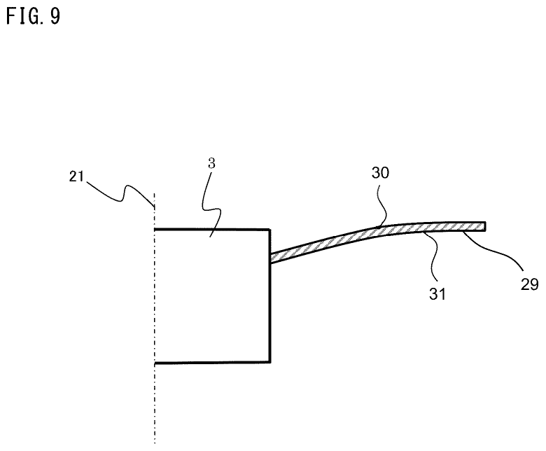

In this Embodiment 4, as shown in FIG. 9, a sensor installation surface 29 of the first pressure sensor 13, the second pressure sensor 14, and the third pressure sensor 15 in the above Embodiment 2 and Embodiment 3 is measured as each back side of the first blade portion 4, the second blade portion 5, and the third blade portion 6, more specifically, as a blade pressure surface 31 side serving as the sensor installation surface 29. Incidentally, each front side of the first blade portion 4, the second blade portion 5, and the third blade portion 6 is a blade negative pressure surface 30.

An installation trace of the pressure sensor is not present on the thus molded front of the blade 2 of the fiber reinforced resin impeller 1, that is, a design surface; and the influence on design can be deleted. Furthermore, the occurrence of noise due to the installation trace (burr) of the pressure sensor can be prevented.

### Embodiment 5

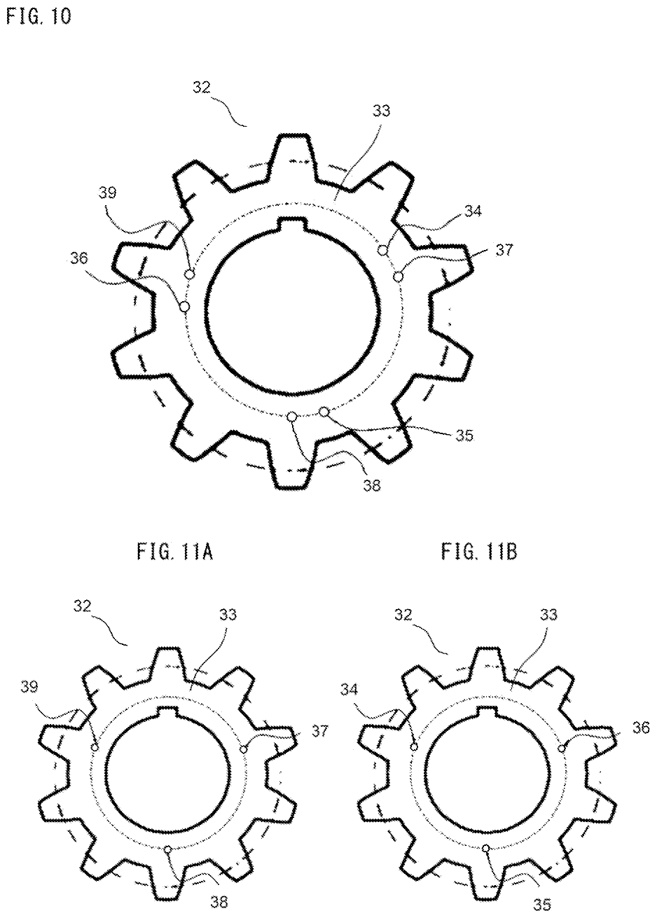

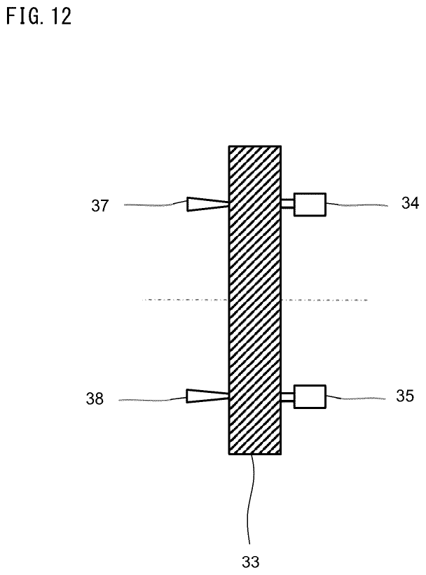

Embodiment 5 of the present application will be described on the basis of FIG. 10 to FIG. 12; and, in each of the drawings, identical or equivalent members and parts will be described with the same reference numerals assigned thereto. FIG. 10 is a plan view showing a fiber reinforced resin gear related to a method of molding the fiber reinforced resin gear according to Embodiment 5. FIGS. 11A and 11B are a plan view showing another example of the fiber reinforced resin gear related to a method of molding the fiber reinforced resin gear according to Embodiment 5, FIG. 11A is a plan view showing the front of the fiber reinforced resin gear, and FIG. 11B is a plan view showing the back of the fiber reinforced resin gear. FIG. 12 is a sectional view seen from lateral directions of FIGS. 11A and 11B in the fiber reinforced resin gear related to the method of molding the fiber reinforced resin gear according to Embodiment 5.

The fiber reinforced resin gear is a gear which uses resin, which contains glass fiber, carbon fiber, or the like, as a material and is molded by an injection molding machine and an injection molding metal mold. The number of teeth of the fiber reinforced resin gear is three or more and a case with ten teeth is shown as an example.

The fiber reinforced resin gear uses glass fiber, carbon fiber, or the like, each of which has a diameter of 5 μm to 15 μm and a length of 0.1 mm to 15 mm. Resin is thermoplastic resin (examples: poly phenylene sulfide (PPS), polybutylene terephthalate (PBT), polypropylene (PP), polystyrene (PS), polycarbonate (PC), acrylonitrile butadiene styrene (ABS), acrylonitrile styrene (AS), and polyether ether ketone (PEEK) ). Furthermore, the percentage of fiber content is 5% to 70% in weight ratio.

In an injection molding metal mold of a fiber reinforced resin gear 32 of this Embodiment 5, a first gate 34, a second gate 35, and a third gate 36 are provided at equal intervals on the circumference of one circle centered on a rotation axis of an injection molded body 33 and are molded by means of a multipoint gate having three or more number of gates.

A first temperature sensor 37, a second temperature sensor 38, and a third temperature sensor 39 are provided in the respective vicinities of the first gate 34, the second gate 35, and the third gate 36. For example, as shown in FIG. 10, when the first temperature sensor 37, the second temperature sensor 38, and the third temperature sensor 39 are located on the same surface as the first gate 34, the second gate 35, and the third gate 36; the first temperature sensor 37, the second temperature sensor 38, and the third temperature sensor 39 are located on the same circumference as the circle on which the first gate 34, the second gate 35, and the third gate 36 are arranged, and the first temperature sensor 37, the second temperature sensor 38, and the third temperature sensor 39 are respectively located at equal intervals from the first gate 34, the second gate 35, and the third gate 36. Then, the first temperature sensor 37, the second temperature sensor 38, and the third temperature sensor 39 are respectively arranged so as to be approximated to the first gate 34, the second gate 35, and the third gate 36 as much as possible.

Orientation of fiber in resin influences the strength of resin. As shown in FIGS. 2A and 2B, when the fiber is oriented in the same direction as a stress direction, the strength of material is high. When the fiber is oriented in a direction perpendicular to the stress direction, the strength of material is weak. Furthermore, the orientation of fiber is influenced by a flow of resin. The strength of material in a flow direction of resin is high; and the strength of material in a width direction of resin is low. When a gate of the metal mold is clogged or when the gate is worn, the flow of resin changes. Under that influence, when the orientation of fiber in the resin changes and the fiber is oriented in a direction perpendicular to the direction of strength request, there exists a risk that links to a deterioration in strength of the gear. Moreover, when the above deterioration in strength occurs, quality cannot be confirmed by the outside appearance of a molded product. When the orientation of fiber is confirmed by computed tomography (CT) scanning, a problem exists that much measurement time and cost are required.

Additionally, the orientation of fiber in the resin influences the dimensions of resin. An injection molded rotor made of fiber reinforced resin generates a difference in shrinkage ratio due to nonuniformity of fiber orientation and a problem arises in that roundness after molding becomes impaired. Countermeasures against this problem are taken by, for example, dimension modification of the metal mold at the time of starting up of the molded product.

In the metal mold after the countermeasures of dimension modification or the like is taken, if the gate of the metal mold is clogged or if the gate is worn during mass production, the flow of resin changes. Under that influence, the orientation of fiber in the resin changes and there exists a risk that links to a dimensional change in the molded product.

Therefore, the temperatures of resin reached the first gate 34, the second gate 35, and the third gate 36 of the metal mold of are respectively measured by the first temperature sensor 37, the second temperature sensor 38, and the third temperature sensor 39; and rise timings are measured per one time of temperature waveforms.

The number of the metal mold of the fiber reinforced resin gear 32 having ten teeth is three. For example, when the first gate 34 of one of them, is clogged or becomes small in diameter and the amount of passing resin is decreased, the rise timing of the first temperature sensor 37 near the first gate 34 is more delayed than normal time. At the same time, the rise timings of the second temperature sensor 38 and the third temperature sensor 39 respectively near the remaining two second gate 35 and third gate 36 are more advanced than normal time. When these phenomena occur, it is turned out that the first gate 34 is clogged and it can be seen that the flow of resin changes and there exists a risk that links to a deterioration in strength of the fiber reinforced resin gear. At this time, a defect signal is outputted to a molding machine, a sorting machine, or the like and molding stop or defect sorting operation can be put in action.

Furthermore, for example, when the first gate 34 of one of them becomes large in diameter due to the wear and the amount of passing resin is increased, the rise timing of the first temperature sensor 37 near the first gate 34 is more advanced than normal time. At the same time, the rise timings of the second temperature sensor 38 and the third temperature sensor 39 respectively near the remaining two second gate 35 and third gate 36 are more delayed than normal time. When these phenomena occur, it is turned out that the first gate 34 is worn; and it can be seen that the flow of resin changes and there exists a risk that links to a deterioration in strength of the fiber reinforced resin gear. At this time, a defect signal is outputted to the molding machine, the sorting machine, or the like and molding stop or defect sorting operation can be put in action.

By this configuration, the resin flow changes when the gate of the metal mold is clogged or when the gate is worn; and thus, a change in fiber orientation can be monitored in real time during molding. The occurrence of a deterioration in strength of the fiber reinforced resin gear can be prevented.

Moreover, it can be monitored in real time during molding whether there exists a change in generation position of a weld (resin interflow portion) of the fiber reinforced resin gear and the occurrence of a deterioration in strength of the gear can be prevented. Furthermore, filling balance of each tooth of the fiber reinforced resin gear can be monitored in real time during molding.

Besides, as another example of FIG. 10 in the above Embodiment 5, description will be made based on, for example, FIGS. 11A and 11B and FIG. 12. As shown in FIGS. 11A and 11B and FIG. 12, there shows a case where a first gate 34, a second gate 35, and a third gate 36 are located on a different surface from a first temperature sensor 37, a second temperature sensor 38, and a third temperature sensor 39 and, more specifically, there shows the case where the first gate 34, the second gate 35, and the third gate 36 are arranged, for example, on the front side of the fiber reinforced resin gear and the first temperature sensor 37, the second temperature sensor 38, and the third temperature sensor 39 are installed at the same positions on the back of the fiber reinforced resin gear on the opposite side of the installation surface of the first gate 34, the second gate 35, and the third gate 36 and at respective positions directly under the first gate 34, the second gate 35, and the third gate 36.

Also in such another example, the same effect as the above Embodiment 5 can be exhibited.

The present application describes various exemplified embodiments and examples; however, various features, aspects, and functions described in one or a plurality of embodiments are not limited to specific embodiments, but are applicable to embodiments individually or in various combinations thereof. Therefore, countless modified examples not exemplified are assumed in technical ranges disclosed in the description of the present application. For example, there include: a case in which at least one constitutional element is modified; a case, added; or a case, omitted; and a case in which at least one constitutional element is extracted to combine with constitutional elements of other embodiments.

### Industrial Applicability

The present application is suitable for actualizing a method of molding a fiber reinforced resin impeller and a method of molding a fiber reinforced resin gear, which can monitor in real time.

### DESCRIPTION OF REFERENCE NUMERALS

1 Fiber reinforced resin impeller, 2 Blade, 3 Drum, 4 First blade portion, 5 Second blade portion, 6 Third blade portion, 7 First gate, 8 Second gate, 9 Third gate, 10 First temperature sensor, 11 Second temperature sensor, 12 Third temperature sensor, 13 First pressure sensor, 14 Second pressure sensor, 15 Third pressure sensor, 16 Fiber, 17 Resin, 18 Flow direction, 19 Width direction, 22 Sensor main body, 23 Resin, 24 Metal mold, 25 Groove for sensor wiring, 26 Sensor wiring, 27 Maximum stress portion, 28 Stress generation direction, 29 Sensor installation surface, 30 Blade negative pressure surface, 31 Blade pressure surface, 32 Fiber reinforced resin gear, 33 Injection molded body, 34 First gate, 35 Second gate, 36 Third gate, 37 First temperature sensor, 38 Second temperature sensor, 39 Third temperature sensor

1. A method of molding a fiber reinforced resin impeller in which fiber reinforced resin is injected from a plurality of gates of a metal mold to mold the fiber reinforced resin impeller which comprises a drum and a plurality of blade portions arranged on the outer circumference of the drum, the method being characterized by:
measuring the temperatures of resin by temperature sensors arranged near a plurality of gate portions of the metal mold which correspond to the blade portions;
measuring rise timings per one time of temperature waveforms collected by the temperature sensors; and
comparing and monitoring the respective rise timings of the temperature sensors.

2. A method of molding a fiber reinforced resin impeller in which fiber reinforced resin is injected from a plurality of gates of a metal mold to mold the fiber reinforced resin impeller which comprises a drum and a plurality of blade portions arranged on the outer circumference of the drum, the method being characterized by:
measuring the pressures of resin by pressure sensors arranged on tip end portions of the plurality of blade portions of the metal mold which correspond to the blade portions; and
measuring peak values per one time of pressure waveforms collected by the pressure sensors and monitoring the states of the peak values.

3. A method of molding a fiber reinforced resin impeller in which fiber reinforced resin is injected from a plurality of gates of a metal mold to mold the fiber reinforced resin impeller which comprises a drum and a plurality of blade portions arranged on the outer circumference of the drum, the method being characterized by:
measuring the pressures of resin by pressure sensors arranged on tip end portions of the plurality of blade portions of the metal mold which correspond to the blade portions;
measuring rise timings per one time of pressure waveforms collected by the pressure sensors; and
comparing and monitoring the respective rise timings of the pressure sensors.

4. The method of molding the fiber reinforced resin impeller according to claim 2, wherein the pressure sensors are measured by being provided on the metal mold, which correspond to the back sides of the blade portions.

5. (canceled)

6. The method of molding the fiber reinforced resin impeller according to claim 3, wherein the pressure sensors are measured by being provided on the metal mold, which correspond to the back sides of the blade portions.
